(19) United States
(12) Patent Application Publication
(10) Pub. No.: US 2012/0136705 A1
(43) Pub. Date: May 31, 2012

(54) CHARGING FEE BILLING METHOD, CHARGING FEE BILLING SYSTEM, CHARGING STAND DEVICE, AUTOMOBILE-MOUNTED CHARGING DEVICE

(75) Inventors: Toshiharu Enmei, Nagoya-shi (JP); Tsutomu Adachi, Nagoya-shi (JP); Shigeru Hayashi, Nagoya-shi (JP); Takezumi Kondo, Nagoya-shi (JP); Hiroshi Maekawa, Nagoya-shi (JP)

(73) Assignee: ADC TECHNOLOGY INC., Nagoya-shi (JP)

(21) Appl. No.: 13/388,205

(22) PCT Filed: Mar. 16, 2011
(86) PCT No.: PCT/JP2011/056278

§ 371 Date: Jan. 31, 2012

(30) Foreign Application Priority Data
Mar. 19, 2010 (JP) 2010-064612

(51) Int. Cl. G06Q 30/06

(52) U.S. Cl. 705/14.17; 705/14.25; 705/14.21

(57) ABSTRACT

In a charging fee billing system according to the invention, a preferential card having preferential information stored thereon is issued, the preferential information allowing for an investor having borne costs required for power storage facilities for use in a commercial power system to receive a discount for electricity fees involved in the charging of an electric automobile. When charging is performed for an electric automobile that is equipped with a preferential card, a charging unit set up at a charging stand acquires preferential information from the preferential card. The charging unit bills a charging fee to which a preferential rate has been applied based on the preferential information acquired from the preferential card.

### CROSS-REFERENCE TO RELATED APPLICATIONS

This international application claims the benefit of Japanese Patent Application No. 2010-64612 filed on Mar. 19, 2010 in the Japan Patent Office, the disclosure of which is incorporated herein by reference.

### TECHNICAL FIELD

The present invention relates to a charging fee billing method for electric automobile.

### BACKGROUND ART

Patent Document 1 below discloses a charging stand for electric automobile provided with a storage battery for electric-load leveling. At the charging stand for electric automobile, the storage battery is charged by late night power service. With the charging power, a storage battery mounted on an electric automobile is charged.

### PRIOR ART DOCUMENT

### Patent Document

Patent Document 1: Unexamined Japanese Patent Application Publication No. 7-115732

### SUMMARY OF THE INVENTION

### Problems to be Solved by the Invention

Electricity fees include facility and operational costs of base power-generation facilities such as for nuclear generation, large-scale thermal power generation, etc., and facility and operational costs of on-demand power-generation facilities such as for small-scale thermal power generation, hydroelectric generation, etc. Thus, the electricity fees during late night hours (late night electricity fee) when demand for electric power is relatively low are determined mainly in consideration of costs required for the base power generation which is inexpensive. The electricity fees during business hours when demand for electric power is high are determined to satisfy the overall costs. Accordingly, the late night electricity fees become inexpensive, while the electricity fees during business hours are expensive.

Such charging system is not considered to largely change even if electric automobiles are generalized and can be charged at home at late night in future, since demand for electric power will not be completely leveled. Further, power-generation facilities must be built always in accordance with peak demand. On-demand power-generation facilities are required by all means.

If electric automobiles are generalized in future, major part of power sources of vehicles which have been covered by fossil fuel will be switched to electricity. Thus, in preparation for increase in demand for electric power, expansion of on-demand power generation facilities is indispensable. On the other hand, at the time when electric automobiles are generalized, it is expected that power storage facilities with imcomparably higher-performance than those at present will be developed.

Accordingly, it is considered that many of the on-demand power generation facilities will be switched to power storage facilities including storage batteries and inverters in future. The power storage facilities store surplus electric power supplied from the base power generation facilities at the time zone when demand for electric power is low, and supplies the stored electric power to consumers at the time zone when demand for electric power is high. In this manner, the power storage facilities serve as conventional on-demand power generation facilities such as for small-scale thermal power generation and hydroelectric generation.

The power storage facilities replacing the on-demand power generation facilities can be large-scale facilities, or small-scale facilities like those provided at home. In either way, somebody has to bear the costs required for expansion for the power storage facilities.

Thus, in order to encourage and promote expansion of the power storage facilities for use in a commercial power system, it would be reasonable to establish a system in which an investor having borne the costs can receive a preferential rate suitable for the borne costs upon charging of an electric automobile of his/hers.

The present invention has been made in consideration of the above circumstances. One object of the present invention is to provide a technique for enabling an investor having borne costs required for power storage facilities for use in a commercial power system to receive preference in charging fee of his/her electric automobile.

### Means to Solve the Problems

A charging fee billing method in a first aspect of the present invention in order to accomplish the above object includes the following steps:

(1) a providing step in which, to an investor having borne costs required for power storage facilities that are connected to a commercial power system, store electric power supplied from the commercial power system and supply the stored electric power to the commercial power system, preferential information on preferential right is created by which a discount for electricity fees involved in charging of a storage battery mounted on an electric automobile for use by the investor can be received, and a preferential information recording medium that stores the created preferential information is given;

(2) an acquisition step in which, upon charging the electric automobile equipped with the preferential information recording medium by a charging stand unit which receives power supply from the commercial power system, the preferential information is acquired from the preferential information recording medium; and

(3) a billing step in which, based on the preferential information acquired from the preferential information recording medium in the acquisition step, a charging fee is billed which is an electricity fee involved in charging of the electric automobile by the charging stand unit to which a preferential rate is applied.

By way of the above described steps, upon charging the electric automobile equipped with the preferential information recording medium at a charging stand, the preferential rate is always applied which includes a discount of electricity fees. An example of the preferential rate herein presupposes a fee system in which a normal rate (e.g., electricity fee during business hours=rather expensive) and a discount rate (e.g., late night electricity fee=rather inexpensive) are set depending on time zones. The above fee system may be operated in such a way that a special discount fee is applied even in a normal rate time zone. Conceptually, electric power stored in a power storage facility of one's own in a discount time zone of electricity fees is drawn out and consumed in a normal time zone.

According to the present invention, those having borne costs required for power storage facilities for use in a commercial power system can enjoy deserved benefit. Thereby, expansion of power storage facilities can be encouraged and promoted.

If preference in charging fee is offered to all vehicles without limitation per one preferential right for charging fee, the preferential right may possibly be used for an electric automobile owned by a third party who is not an investor for a power storage facility. Such use is against the spirit of the present invention which is to grant a deserved privilege to investors having borne costs required for power storage facilities. It is possible that the preference system becomes ineffective.

Thus, it is preferable that the charging fee billing method in a second aspect may be configured as follows. Particularly, the preferential information created in the providing step includes identification information for specifying an electric automobile which can receive preference in charging fee. In the billing step, the electric automobile is authenticated based on the identification information included in the preferential information. The preferential rate is applied only to the electric automobile being complied with the identification information.

With the configuration above, it is possible to limit vehicles which can receive preference in charging fee to specified vehicles (e.g., electric automobiles for use by investors for power storage facilities). Effectiveness of the preference system can be increased.

The charging fee billing method in a third aspect further includes a storage step in which charging information showing actual results of charging which has been performed at the preferential rate to the electric automobile equipped with the preferential information recording medium. The preferential information created in the providing step includes limitation information showing limitation to charging density up to which the preferential rate can be applied. In the billing step, the preferential rate is applied to the electricity fees involved in charging within a limited range for the charging density shown by the limitation information, based on the limitation information included in the preferential information and the charging information stored in the preferential information recording medium.

The charging density herein indicates a number of charging times or an amount of charging power within a certain period of time (e.g., a day, a week or a month). The charging information may be stored in the individual preferential information recording media. Or, all the charging stands may be connected to a network, and the charging information on all the preferential information recording media may be centrally managed by a management server on the network.

Setting limitation to the charging density up to which the preferential rate can be applied inhibits excess preference which does not fit to the size of the investment in power storage facilities. An effective preference system can be realized which can adhere to the spirit of the present invention that is to grant a deserved privilege to investors having borne costs required for power storage facilities. There is another purpose of providing limitation to the charging density. Drivers who seldom use their vehicles can also take advantage of the preference system at low cost.

The charging fee billing method in a fourth aspect further includes a storage step in which charging information showing actual results of charging which has been performed at the preferential rate to the electric automobile equipped with the preferential information recording medium is stored. Further, the preferential information created in the providing step includes return information showing a condition for returning the charging fee in case that charging covered at the preferential rate is smaller than the previously arranged charging density. In the billing step, if the actual results of the charging density based on the charging information stored in the preferential information recording medium are smaller than the previously arranged charging density based on the return information included in the preferential information, return money corresponding to an amount less than the previously arranged charging density is deducted from the charging fee.

With the configuration above, an investor who uses less amount of power for charging than the amount of power deserved for the size of the investment in power storage facilities can receive profits return corresponding to the surplus amount of power. The purpose of this mechanism is, since the capacity of power storage facilities can be effectively used for other application if the investor does not use the invested power storage facilities for charging of his/her vehicle, to enable the investor to receive part of the profits thereby produced in the form of return of the charging fee.

Now, a charging fee billing system in a fifth aspect of the invention which has been made to achieve the above object includes a charging stand device and an automobile-mounted charging device. The charging stand device receives supply of electric power from a commercial power system. The automobile-mounted charging device is mounted on an electric automobile. The charging stand device and the automobile-mounted charging device are electrically connected via each other's charging terminals. Thereby, a storage battery mounted on the electric automobile is charged and the charging fee is billed.

Particularly, the automobile-mounted charging device includes a charging unit, a preferential information storage unit, an automobile-mounted communication unit, and a transmission unit. The charging unit receives power supply from the charging stand device by electrically connecting with the charging stand device via each other's charging terminals to charge a storage battery mounted on the electric automobile. The preferential information recording unit stores preferential information on preferential right of receiving a discount for electricity fees involved in charging of the electric automobile, which is granted to an investor having borne costs required for a storage battery for use in a commercial power system. The automobile-mounted communication unit is for information communication with the charging stand device. The transmission unit transmits contents stored in the preferential information storage unit to the charging stand device via the automobile-mounted communication unit.

The charging stand device includes a stand-side charging unit, a stand-side communication unit, an acquisition unit, and a billing unit. The stand-side charging unit supplies electric power for charging the storage battery mounted on the electric automobile to the automobile-mounted charging device by electrically connecting with the automobile-mounted charging device via each other's charging terminals. The stand-side communication unit is for information communication with the automobile-mounted charging device. The acquisition unit acquires information stored in the preferential information storage unit provided in the automobile-mounted charging device. The billing unit bills a charging fee which is an electricity fee involved in charging of the electric automobile to which a preferential rate is applied, based on the preferential information acquired from the automobile-mounted charging device by the acquisition unit.

The charging fee billing system configured as above is a charging fee billing system including a charging stand device and an automobile-mounted charging device, to which the charging fee billing method according to the first aspect is applied. According to the above charging fee billing system, the aforementioned effect can be achieved.

The charging fee billing system in a sixth aspect has the following feature. The preferential information includes identification information for specifying an electric automobile which can receive preference in charging fee. The billing unit of the charging stand device authenticates the electric automobile based on the identification information included in the preferential information. The preferential rate is applied only to the electric automobile being complied with the identification information. According to the present charging fee billing system configured as above, the effect described for the charging fee billing method in the second aspect can be achieved.

The charging fee billing system in a seventh aspect has the following feature. The preferential information includes limitation information showing limitation for charging density to which the preferential rate can be applied. The automobile-mounted charging device further includes a storage unit that stores in a preferential information recording unit charging information showing actual results of charging which has been performed at the preferential rate. The billing unit of the charging stand device authenticates the electric automobile based on the identification information included in the preferential information, and applies the preferential rate only to the electric automobile being complied with the identification information. According to the present charging fee billing system configured as above, the effect described for the charging fee billing method in the third aspect can be achieved.

The charging fee billing system in an eighth aspect has the following feature. The preferential information includes return information showing a condition for returning the charging fee in case that charging covered at the preferential rate is smaller than the previously arranged charging density. The automobile-mounted charging device further includes a storage unit that stores in a preferential information recording unit charging information showing actual results of charging which has been performed at the preferential rate. The billing unit of the charging stand device, if the actual results of the charging density based on the charging information stored in the preferential information recording unit are smaller than the previously arranged charging density based on the return information included in the preferential information, deducts return money corresponding to an amount less than the previously arranged charging density from the charging fee. According to the present charging fee billing system configured as above, the effect described for the charging fee billing method in the fourth aspect can be achieved.

The charging fee billing system in a ninth aspect is characterized in that the charging stand device and the automobile-mounted device are chargeable connected via charging terminals so that the automobile-mounted communication unit and the stand-side communication unit can perform information communication with each other. With this configuration, upon charging an electric automobile at a charging stand, a communication procedure required for applying a preferential rate can be conveniently performed without special manipulation.

A charging stand device in a tenth aspect constitutes one of the charging fee billing systems in the fifth to ninth aspects. According to the charging stand device, the aforementioned charging fee billing systems can be established. Thereby, the aforementioned effects can be achieved.

An automobile-mounted charging device in an eleventh aspect constitutes one of the charging fee billing systems in the fifth to ninth aspects. According to the automobile-mounted charging device, the aforementioned charging fee billing systems can be established. Thereby, the aforementioned effects can be achieved.

### BRIEF DESCRIPTION OF THE DRAWINGS

FIG. 1 is a diagram showing an overall configuration of a charging fee billing system.

FIG. 2 is an explanatory view showing a storage battery of an electric automobile being charged by a charging unit installed at a charging stand.

FIG. 3A is an explanatory view showing an electric automobile being charged at a charging stand according to the present embodiment. FIG. 3B is an explanatory view showing an electric automobile being charged by nighttime power at home.

FIG. 4 is a block diagram showing a schematic configuration of a charging unit and an automobile-mounted charging unit.

FIG. 5A is a flowchart showing steps of a process relating to receipt of and response to a feed command. FIG. 5B is a flowchart showing steps of a process relating to output control of a power station.

FIG. 6A is a flowchart showing steps of a process relating to receipt of and response to a discharge/store command. FIG. 6B is a flowchart showing steps of a process relating to discharge control of a power storage station. FIG. 6C is a flowchart showing steps relating to storage control of a power storage station.

FIG. 7A is a flowchart showing steps of a process relating to transmission and reception of information from and to each facility to be controlled/managed. FIG. 7B is a flowchart showing steps of determining a wholesale price of electricity fees and return money at a feed command center.

FIG. 8A is a flowchart showing steps of a process relating to installation of a power storage facility. FIG. 8B is a flowchart showing steps of a process of issuing a preferential card to an investor having borne costs required for a power storage facility.

FIG. 9 is an explanatory view showing types of the preferential card.

FIG. 10A is a flowchart showing steps of a process relating to information communication with the feed command center. FIG. 10B is a flowchart showing steps of a process relating to settlement of electricity fees for electric power sold at a charging stand.

FIG. 11 is a flowchart showing steps of a process executed by a control device of the charging unit installed at the charging stand.

FIG. 12 is a flowchart showing steps of a process executed by a fee adjustment machine of the charging unit installed at the charging stand.

FIG. 13 is a flowchart showing steps of a process executed by a control device of the automobile-mounted charging unit.

FIG. 14A is a flowchart showing steps of a process of issuing a privilege point to a user of the fee adjustment machine at the charging stand side. FIG. 14B is a flowchart showing steps of a process of accumulating the privilege point in the preferential card by the automobile-mounted charging unit.

### EXPLANATION OF REFERENCE NUMERALS

1 . . . power station, 2 . . . power storage station, 3 . . . feed command center, 4 . . . power storage facility managing organization, 5 . . . charging stand, 50 . . . charging unit, 51 . . . charging connector, 52 . . . charging machine, 53 . . . control device, 54 . . . serial communication I/F, 55 . . . data communication I/F, 56 . . . communication line I/F, 57 . . . fee adjustment machine, 60 . . . automobile-mounted charging unit, 61 . . . charging connector, 62 . . . charging machine, 63 . . . storage battery, 64 . . . control device, 65 . . . serial communication I/F, 66 . . . card connector, 67 . . . preferential card, 70 . . . household use charging device.

### MODE FOR CARRYING OUT THE INVENTION

Hereinafter, one embodiment of the present invention will be described based on the accompanying drawings. The present invention is not limited to the below embodiment, and can be practiced in various modes.

[Description of Overall Configuration of Charging Fee Billing System]

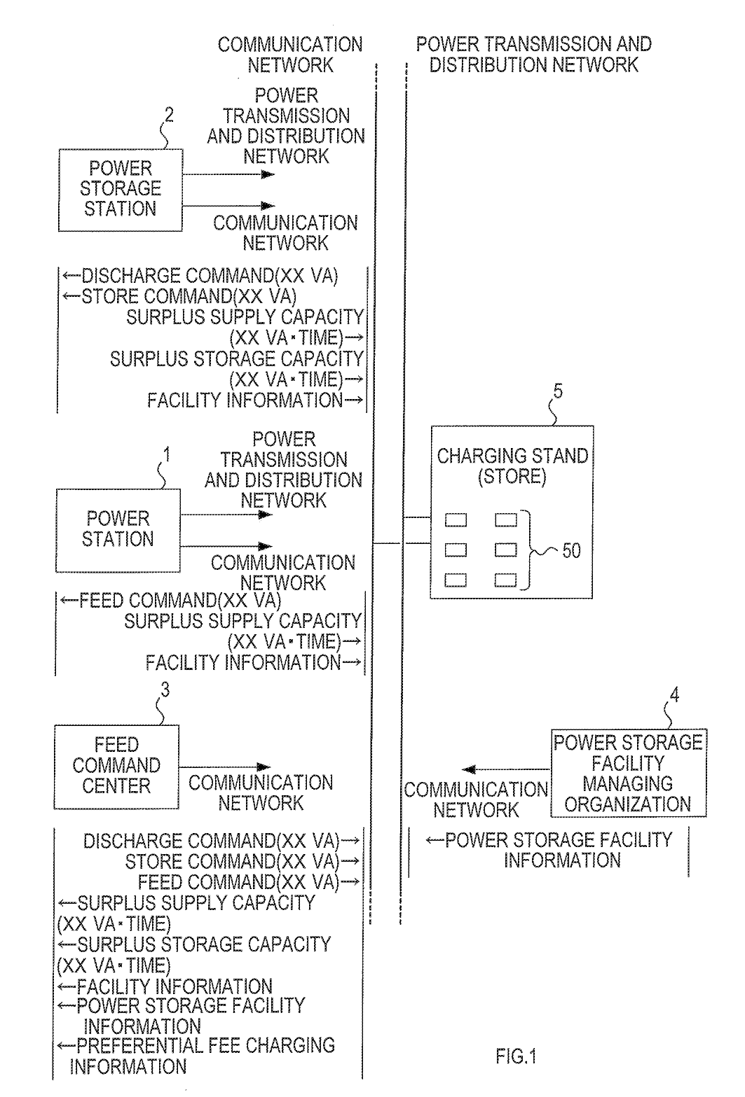

As shown in FIG. 1, a charging fee billing system of the present embodiment includes a power station 1, a power storage station 2, a feed command center 3, a power storage facility managing mechanism 4, and a charging stand 5.

The power station 1 is a facility which utilizes energy of such as nuclear power, thermal power and hydraulic power to generate electric power, and supplies the generated electric power to a commercial power system through a power transmission and distribution network. In the present embodiment, a generation control information processor performs target output control based on a command from the feed command center 3. Thus, the generation control information processor receives a feed command from the feed command center and transmits surplus supply capacity and facility information to the feed command center 3 through a communication network.

As for the target output control of the power station, there are various control methods, depending on generation methods of such as nuclear power, thermal power and hydraulic power. The nuclear power generation covers a base part of total power demand. Load-follow operation is not performed, and nearly rated output operation is performed. The thermal power generation has higher generating efficiency than other generation methods and is easy to adjust its output. Thus, the thermal power generation performs power supply-demand adjustment day and night. High efficiently operation is also performed. The hydraulic power generation mainly covers a peak part of total power demand. These control methods are in common use. In any of the generation methods, due energy consumption accompanies power generation, and there are limitations relating to facilities in control method. For example, if there is no need to take into consideration the limitations relating to facilities, a feed command is given to each power station so as to minimize operation costs.

The power storage station 2 is a power storage facility for connection to a commercial power system provided with a rechargeable battery, a capacitor, a charging device, an inverter and so on. The power storage station 2 mainly stores electric power supplied from the commercial power system through a power transmission and distribution network during nighttime hours when power demand is low, and supplies the stored electric power to the commercial power system through the power transmission and distribution network at a time zone when power demand hits a peak, thereby to perform load leveling. Also in the present embodiment, a storage and discharge control information processor installed at the power storage station 2 performs storage and discharge control, based on a command from the feed command center 3. Thus, the storage and discharge control information processor receives a storage command and a discharge command from the feed command center and transmits surplus storage capacity, a surplus supply capacity, and facility information to the feed command center 3, through a communication network. It is assumed that such operation is performed in mainly a large-scale power storage facility. In a small-scale power storage facility, operation of storing electric power during nighttime hours and discharging the electric power during daytime hours is performed by self-sustained operation.

The feed command center 3 is a facility which, based on a long-term plan, a medium-term plan and a short-term plan relating to operation of a commercial power system, integrally performs output control of the power station 1 and charge and discharge control of the power storage station 2, so as to ensure consistency between supply and demand of electric power. Thus, a control/managing information processor installed at the feed command center 3 transmits a feed command to the power station 1, a store and discharge command to the power storage station 2, and receives surplus supply capacity, surplus storage capacity, and facility information from the power station 1 and the power storage station 2 through a communication network. The control/managing information processor also receives various information such as power storage facility information from the storage facility managing mechanism 4, preferential rate charging information from the charging stand 5, etc., through the communication network. Based on the information received from the respective facilities, the control/managing information processor comprehensively determines control methods to the power station 1 and the power storage station 2.

The storage facility managing organization 4 is an organization that registers a power storage facility for use in a commercial power system with the feed command center, and issues a preferential card which enables an investor having borne costs required for power storage facilities for use in a commercial power system to receive preference in charging fee of an electric automobile. The preferential card, for example, is configured as an IC card or the like embedded with an integrated circuit which stores and calculates data. In the preferential card, preferential information is recorded for receiving a discount of electricity fees involved in charging a storage battery mounted on an electric automobile.

The charging stand 5 is a facility which sells services of charging a storage battery of an electric automobile. Electric power for charging an electric automobile is supplied from a commercial power system through a power transmission and distribution network. At the charging stand 5, a plurality of charging units 50, each of which unitizes a charging machine for charging a storage battery of an electric automobile, a communication device and a control device, and a central control information processor, are installed. A user parks his/her electric automobile next to the charging unit 50 and charges the electric automobile on the spot. After the charging, the user pays a charging fee calculated by a fee adjustment machine associated with the charging unit 50.

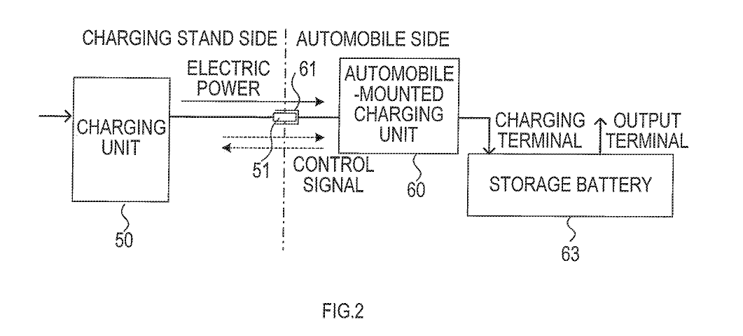

As shown in FIG. 2, a feed path is formed by connecting respective charging connectors 51 and 61 of the charging unit 50 and the automobile-mounted charging unit 60. Via the feed path, charging power is supplied from the charging unit 50 to the automobile-mounted charging unit 60. With the supplied charging power, the automobile-mounted charging unit 60 charges the storage battery 60 of the electric automobile.

Upon charging, predetermined information communication is performed between the charging unit 50 and the automobile-mounted charging unit 60. At this time, communication between the charging unit 50 and the automobile-mounted charging unit 60 is made by means of the feed path formed by connecting the respective charging connectors 51 and 61. For example, a communication line individually provided along a power feeding cable may be used to transmit and receive a control signal. Or, power line carrier communication may be used which utilizes a power feeding cable for supplying charging power as a communication circuit.

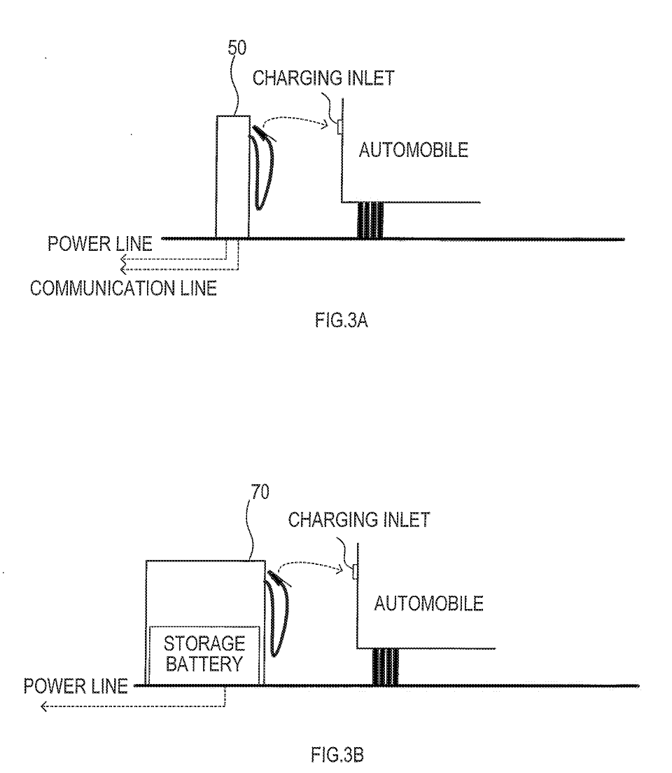

In charging by the charging stand shown in FIG. 3A, commercial power supplied via a power transmission and distribution network is supplied from the charging unit 50 to an electric automobile. In this case, depending on the time zone (business hours/late night hours) when the charging is performed, electricity fees involved in charging fees differ. An expensive normal rate is applied to charging during business hours, while a discount rate is applied to charging during late night hours. Also in the present embodiment, a discount rate is exceptionally applied to a user having a preferential right granted to an investor for power storage facilities for use in a commercial power system even in the time zone of normal rate.

In charging at home shown in FIG. 3B, in a late night time zone when electricity fees are inexpensive, commercial power supplied via a power transmission and distribution network is temporarily stored in a storage battery included in a nighttime power storage type automobile charging device (hereinafter, a household use charging device) 70. The power stored in the storage battery is supplied from the household use charging device 70 to an electric automobile. In this case, as long as the charging is performed within a range of electric power stored in the storage battery, charging can be always performed at a discount rate.

[Description of Configurations of Charging Unit and Automobile-Mounted Charging Unit]

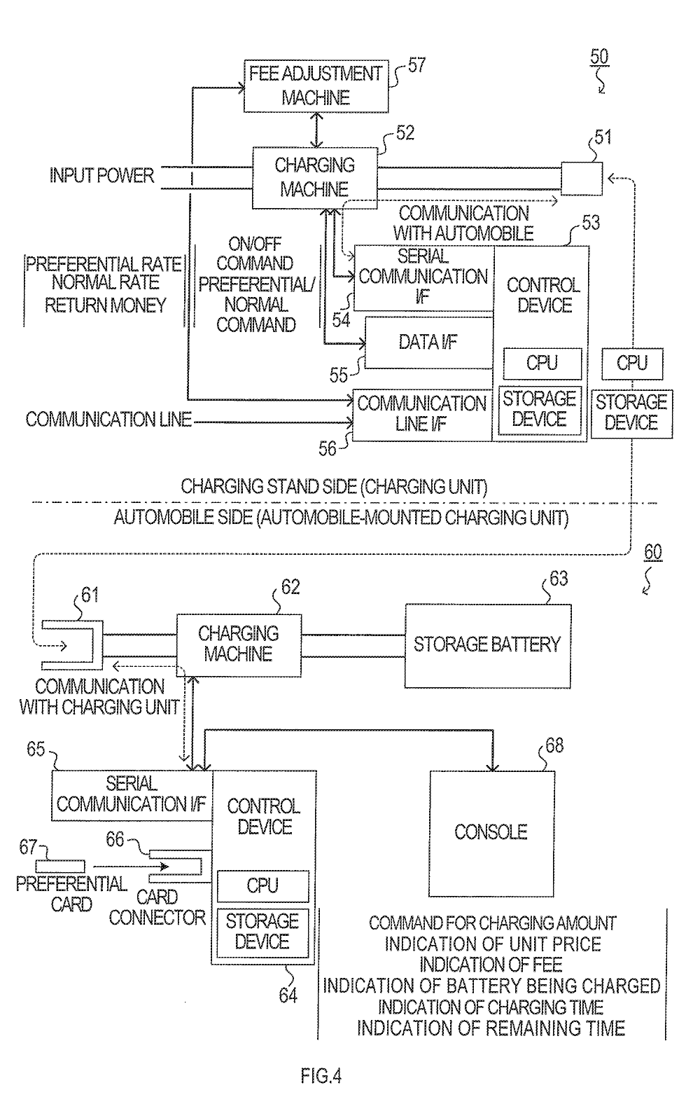

Next, schematic configurations of the charging unit 50 arranged at the charging stand 5 and the automobile-mounted charging unit 60 mounted on an electric automobile will be described by way of FIG. 4.

The charging unit 50 includes the charging connector 51, a charging machine 52, a control device 53, a serial communication interface (I/F) 54, a data interface (I/F) 55, a communication line interface (I/F) 56, a fee adjustment machine 57 and others.

The charging connector 51 is a connecting terminal for enabling to supply charging power by connecting with the charging connector 61 on the automobile-mounted charging unit 60 side upon charging. The charging connector 51 also serves as a connecting terminal for communicable connection between the charging unit 50 and the automobile-mounted charging unit 60. The charging machine 52, based on a command from the control device 53, converts the inputted commercial power to a voltage and current adapted to the specification of an electric automobile to be charged, and outputs the converted voltage and current to the automobile-mounted charging unit 60 side via the charging connector 51. The charging machine 52 also outputs information on an amount of the outputted power to the fee adjustment machine 57.

The control device 53 is a computer which includes a known CPU, storage devices (RAM and ROM), and others. These components are connected to respective interfaces. The control device 53 integrally controls the respective components of the charging unit 50 and communicates information with external apparatus. Various processes by the control device 53 are performed by the CPU executing programs stored in a storage device provided in the control device 53. Interfaces for various communications such as the serial communication I/F 54, the data I/F 55 and the communication line I/F 56 are connected to the control device 53.

The serial communication I/F 54 communicates information with the automobile-mounted charging unit 60 on an electric automobile side through the charging connector 51. The data I/F 55 communicates information with the charging machine 52. Commands for start/end (ON/OFF) charging to the charging machine 52, data on the amount of charging power and so on are transmitted. The communication line I/F 56 communicates with the fee adjustment machine 57 and external apparatus via a communication line. In the communication with the fee adjustment machine 57, information on a unit selling price (preferential rate/normal rate) of charging fee, and a unit price of return money, etc. are transmitted. In the communication with the external apparatus, information relating to unit prices of electricity fees (preferential rate/normal rate) and return money, an amount of sold charging power, etc. is transmitted from/to the central control information processor installed at the charging stand 5.

The fee adjustment machine 57 settles a charging fee. The fee adjustment machine 57, based on the various information (unit selling price of charging fee, unit price of return money, amount of charging power) inputted from the charging machine 52 and the control device 53, calculates a charging fee, and receives payment (makes settlement) of the charging fee from the user. Settlement of the charging fee can be made by any one of the methods of cash, credit card, prepaid card, electronic money, and others.

The automobile-mounted charging unit 60 includes the charging connector 61, the charging machine 62, a storage battery 63, a control device 64, a serial communication interface (I/F) 65, a card connector 66, a preferential card 67, a console 68, and others.

The charging connector 61 is a connecting terminal for receiving charging power by connecting with the charging connector 51 on the charging unit 50 side upon charging. The charging connector 61 also serves as a connecting terminal for communicable connection between the automobile-mounted charging unit 60 and the charging unit 50. The charging machine 62, based on a command from the control device 64, charges the storage battery 63 with the charging power inputted from the charging unit 50 side via the charging connector 61.

The control device 64 is a computer which includes a known CPU, storage devices (RAM and ROM), and others. These components are connected to respective interfaces. The control device 64 integrally controls the respective components of the automobile-mounted charging unit 60 and communicates information with external apparatus. Various processes by the control device 64 are performed by the CPU executing programs stored in the storage devices provided in the control device 64. Interfaces for various communications such as the serial communication I/F 65, the card connector 66, etc. are connected to the control device 64.

The serial communication I/F 65 is an interface for the charging machine 62 to communicate information with the console 68 and the charging unit 50. The communication with the charging unit 50 on the charging stand 5 side is performed through the charging connector 61. The card connector 66 is a card reader/writer having a card slot. The card connector 66 reads information stored in the preferential card 67 inserted to the card slot to be outputted to the control device 64 and writes the information inputted from the control device 64 on the preferential card 67.

The preferential card 67 is a so-called IC card, embedded with an integrated circuit which stores and calculates data. The preferential card 67 stores information relating to preferential right (preferential information) for receiving a discount of electricity fees involved in charging of an electric automobile. The preferential card 67 is issued to an investor having borne costs required for power storage facilities for use in a commercial power system. The preferential card 67 is used by being inserted to the card connector 66 of the automobile-mounted charging unit 60. The preferential card 67 also has a predetermined security function for preventing unauthorized use of preferential right and personal information. The preferential information stored in the preferential card 67 includes information such as license information (e.g., vehicle number, vehicle body number, etc.) for specifying a vehicle which can receive preference, and fee preferential class information (type of preference, discount rate, limitation of charging density, presence/absence of fee return, etc.). With the preferential card 67, charging can be done at a preferential rate equivalent or close to an inexpensive nighttime electricity fee even during daytime hours when electricity fees are rather expensive.

The console 68 is a user interface for displaying information for an occupant of an electric automobile and receiving an operating instruction from the occupant. The console 68 includes a display device such as a liquid crystal monitor, a touch panel, a key switch, and others. The console 68, based on the operating instruction from the user, instructs the control device 64 an amount of charging power to buy (full charge, an amount corresponding to XX KWh, an amount corresponding to YY yen, and so on). The console 68 also displays on a monitor various information such as indication of the unit price for the charging fee, fee, battery being charged, charging time, remaining time, etc., based on an inputted data from the control device 64.

[Description of Processes Executed at Power Station 1]

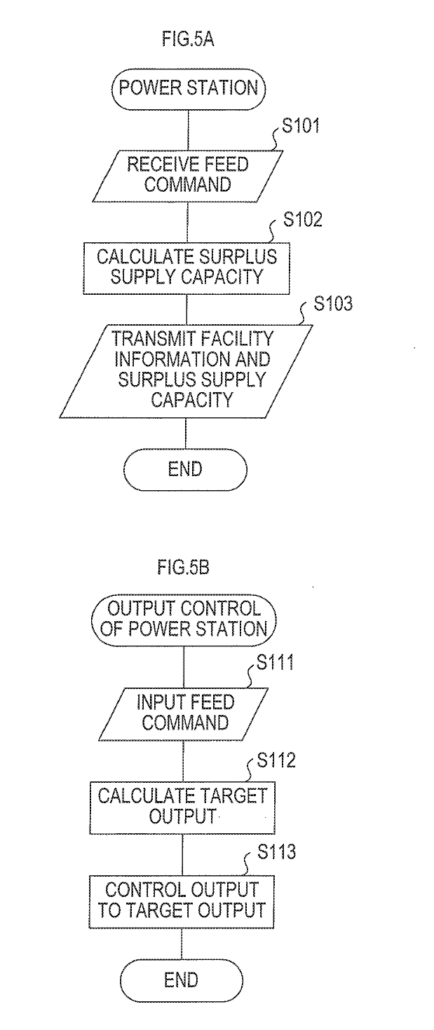

Next, processes executed at the power station 1 will be described based on flowcharts of FIGS. 5A and 5B.

The process shown by the flowchart of FIG. 5A is executed by a power control information processor installed at the power station 1. The information processor of the power station 1 firstly receives a feed command from the feed command center 3 (S101). Information in the feed command includes generated power (VA) requested to be outputted. Subsequently, in response to the received feed command, surplus supply capacity (VA·time) in a current operation condition of the power station 1 is calculated (S102). Then, the information processor transmits facility information including identification information of its own power station 1, maximum generated power (VA) which can be outputted, time period during which maximum output can be maintained, generated power (VA) which can be continuously outputted, etc., and the surplus supply capacity calculated in S102 to the feed command center 3 (S103).

The process shown by the flowchart of FIG. 5B is executed by the power control information processor installed at the power station 1. The information processor of the power station 1 firstly inputs the feed command received in the above S101 (S111). Subsequently, target output of a power source for acquiring generated power corresponding to the feed command is calculated (S112). An output of the power source of the power station 1 is controlled to the target output calculated in S112 (S113).

[Description of Processes Executed at Power Storage Station 2]

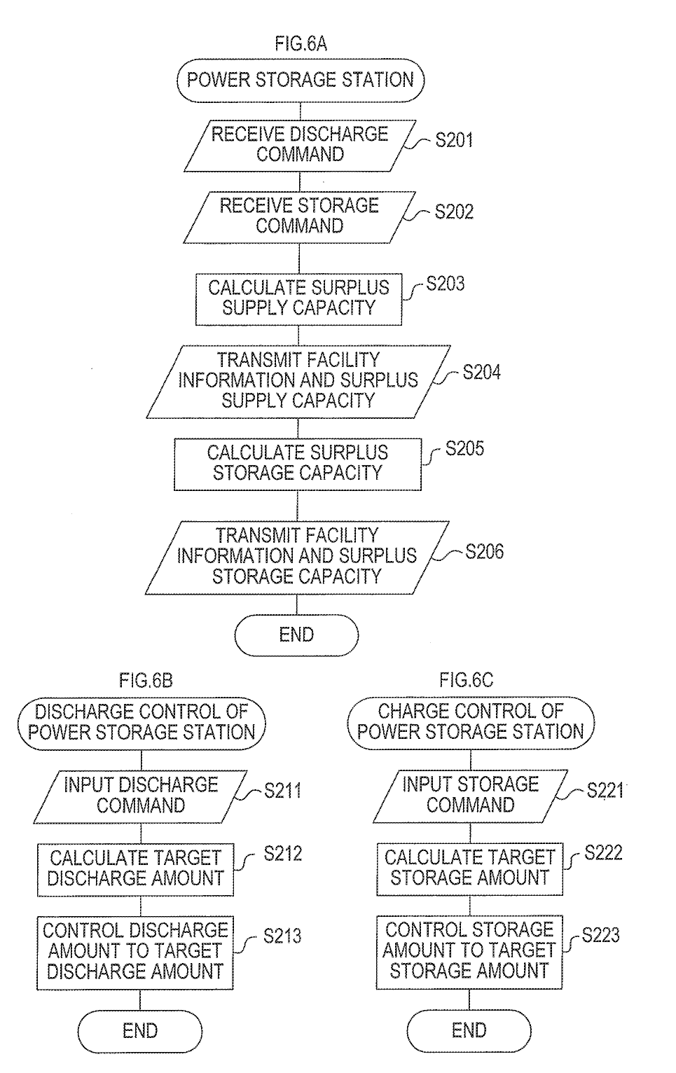

Next, processes executed at the power storage station 2 will be described based on flowcharts of FIGS. 6A, 6B and 6C.

The process shown by the flowchart of FIG. 6A is executed by a charging and discharging control information processor installed at the power storage station 2. The information processor of the power storage station 2 receives a discharge command from the feed command center 3 in S201. Information in the discharge command includes discharge power (VA) requested to be outputted. In S202, the information processor receives a store command from the feed command center 3. Information in the store command includes power (VA) requested to be absorbed.

Subsequently, in response to the discharge command received in S201, surplus supply capacity (VA·time) in a current amount of stored power of the power storage station 2 is calculated (S203). Then, the information processor transmits facility information including identification information of its own power storage station 2, maximum discharge power (VA) which can be outputted, time period during which maximum output can be maintained, maximum power storage capacity (VAh), etc., and the surplus supply capacity calculated in S203 to the feed command center 3 (S204).

In response to the store command received in S202, surplus storage capacity (VA·time) in a current spare capacity of the power storage station 2 is calculated (S205). Then, the information processor transmits facility information including identification information of its own power storage station 2, maximum discharge power (VA) which can be outputted, time period during which maximum output can be maintained, maximum power storage capacity (VAh), etc., and the surplus storage capacity calculated in S205 to the feed command center 3 (S206).

The process shown by the flowchart of FIG. 6B is executed by the charging and discharging control information processor installed at the power storage station 2. The information processor of the power storage station 2 firstly inputs the discharge command received in the above S201 (S211). Subsequently, a target discharge amount corresponding to the discharge command is calculated (S212). A discharge amount to be outputted from the power storage station 2 to a commercial power system is controlled to the target discharge amount calculated in S212 (S213).

The process shown by the flowchart of FIG. 6C is executed by the charging and discharging control information processor installed at the power storage station 2. The information processor of the power storage station 2 firstly inputs the store command received in the above S202 (S221). Subsequently, a target storage amount corresponding to the store command is calculated (S222). A storage amount to be taken into the storage battery from a commercial power system is controlled to the target discharge amount calculated in S222 (S223).

[Description of Processes Executed at Feed Command Center 3]

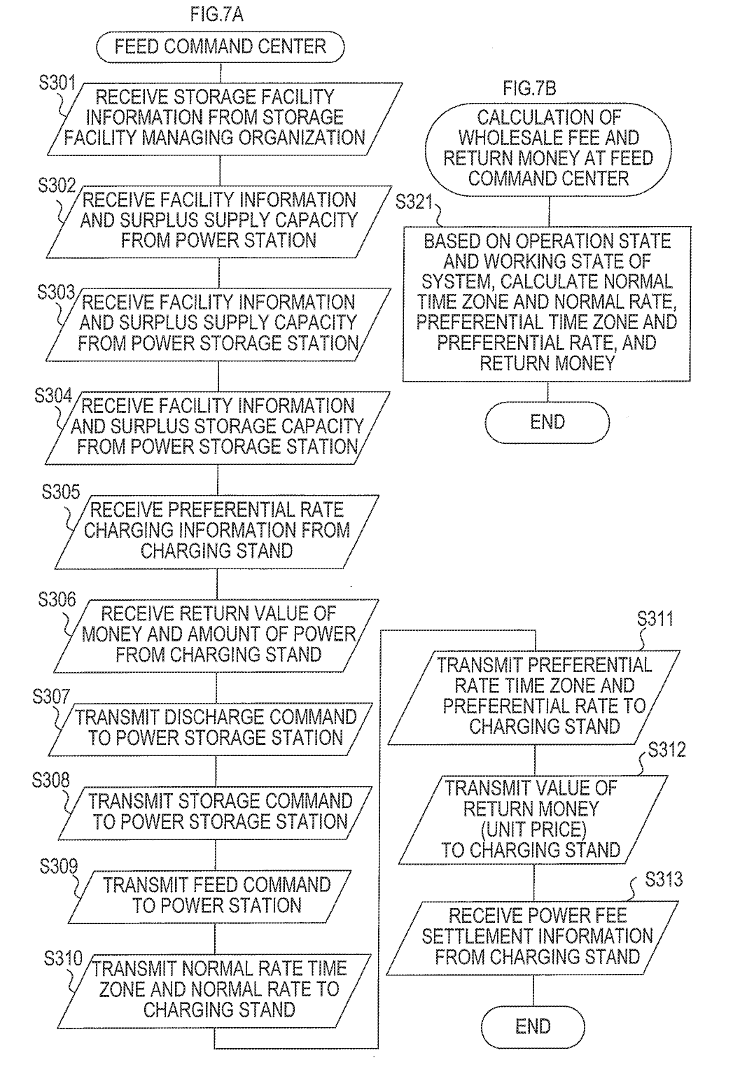

Next, processes executed at the feed command center 3 will be described based on flowcharts of FIGS. 7A and 7B.

The process shown by the flowchart of FIG. 7A is executed by the control/managing information processor installed at the feed command center 3. The information processor of the feed command center 3 receives power storage facility information from the storage facility managing organization 4 in S301. The power storage facility information includes various information (identification information, maximum power storage capacity, owner, etc.) relating to registration of a newly installed power storage facility. At the feed command center 3 which has received the power storage facility information, the newly installed power storage facility is registered as a power storage facility to be managed.

In S302, the facility information and the surplus supply capacity from the power station 1 are received. In S303, the facility information and the surplus supply capacity from the power storage station 2 are received. In S304, the facility information and the surplus storage capacity from the power storage station 2 are received. The information processor of the feed command center 3, based on the information received in S302, S303 and S304, comprehensively determines the control methods to be applied to the power station 1 and the power storage station 2 so that consistency is assured between supply and demand of electric power.

In S305, the preferential rate charging information is received from the charging stand 5. The preferential rate charging information shows actual results of charging at the preferential rate performed at the charging stand 5 in a time zone when normal electricity fees are applied. In S306, return money and an amount of power when return of charging fee is applied are received from the charging stand 5.

In S307, a discharge command is transmitted to the power storage station 2. The discharge command is mainly issued in a time zone when demand for electric power is high. Contents of the discharge command to the power storage station 2 are determined based on a balance of supply and demand of electric power in a commercial power system, taking into account the preferential rate charging information and the amount of power to which return of fee is applied which are received in S305 and S306. Specifically, the power storage station 2, which is owned by a user who has exercised his/her preferential right such as application of preferential rate in a time zone of normal rate and return of a charging fee (of which costs have been borne by the user), is controlled to discharge a due amount of power.

In S308, a store command is transmitted to the power storage station 2. The store command is mainly issued in a time zone when electricity demand is low. The contents of the store command to the power storage station 2 are determined based on the balance of supply and demand of electric power in the commercial power system. In S309, a feed command is transmitted to the power station 1. The contents of the feed command to the power station 1 are determined based on the balance of supply and demand of electric power in the commercial power system.

In S310, a time zone when daytime normal electricity fees are applied and a unit price (yen/VAh) at the normal rate are transmitted to the charging stand 5. In S311, a time zone when a nighttime preferential rate is applied and a unit price (yen/VAh) at the preferential rate are transmitted to the charging stand 5. In S312, a unit price (yen/VAh) of return money per amount of power to an investor having borne costs required for power storage facilities for use in the commercial power system is transmitted. At the charging stand 5, a charging fee is settled based on the normal rate time zone and preferential rate time zone, and unit prices at the normal rate, preferential rate and return money notified in S310, S3111 and S312.

In S313, power fee settlement information is received from the charging stand 5. The power fee settlement information shows a fee relating to the amount of charging power sold at the charging stand 5. The feed command center 3 bills electricity fees to the charging stand 5 based on the power fee settlement information.

The process shown by the flowchart of FIG. 7B is executed by the control/managing information processor installed at the feed command center 3. The information processor of the feed command center 3, based on an operational and working state of a system, calculates a unit price (yen/VAh) in a time zone when daytime normal electricity fees are applied and at a normal rate, a unit price (yen/VAh) in the time zone when the nighttime preferential rate is applied and at the preferential rate, a unit price (yen/VAh) of return money (S321). Determination of the normal rate, preferential rate and return money requires an advanced statistical work on managing and political information. However, since particulars of the determination are not the gist of the present invention, explanation thereof is omitted.

[Description of Processes Executed at Power Storage Facility Managing Organization 4]

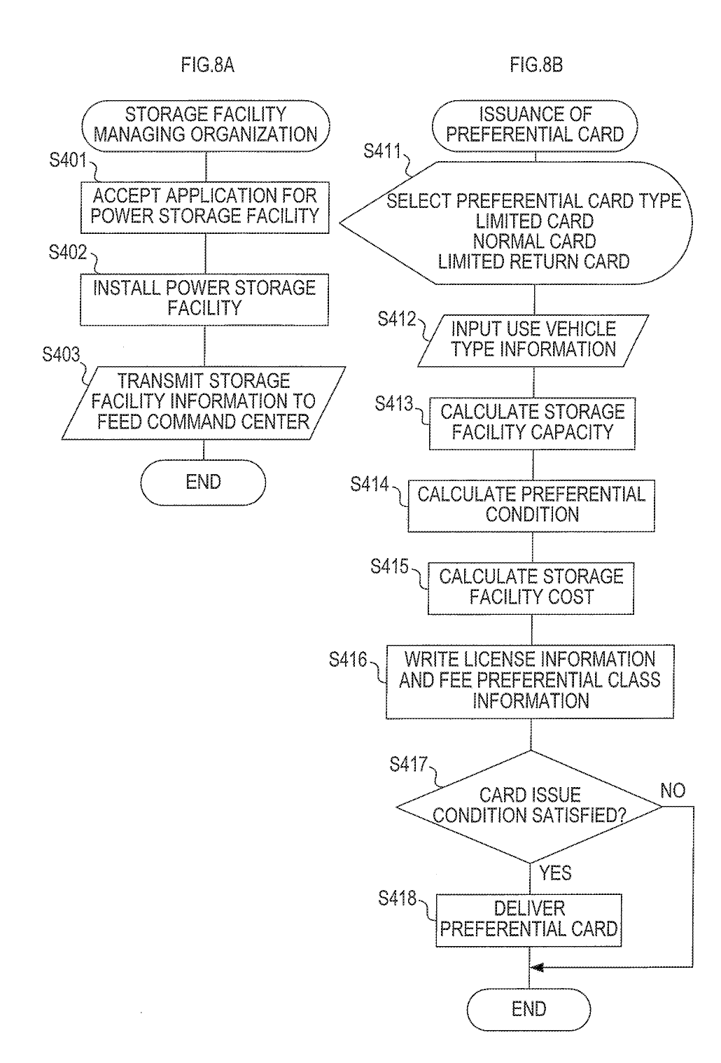

Next, processes executed at the power storage facility managing mechanism 4 will be described based on flowcharts of FIGS. 8A and 8B.

The process shown by the flowchart of FIG. 8A is executed by a managing information processor installed at the power storage facility managing organization 4. The information processor of the power storage facility managing organization 4 accepts application of installation of a power storage facility for use in a commercial power system from a user in S401. The user invests his/her money in a power storage facility, depending on his/her fund and capacity, use, etc. of his/her electric automobile. Subsequently, in S402, based on information applied in S410, the information processor processes information required for installation of the power storage facility. Based on the result of this processing, a power station 2 is built and a power storage facility for use in a commercial power system is installed. In S403, the information processor transmits power storage facility information relating to registration of the installed power storage facility to the feed command center 3. The power storage facility information includes identification information, maximum power storage capacity, owner, etc. of the newly installed power storage facility.

The process shown by the flowchart of FIG. 8B is executed by a preferential card issuing information processor installed at power storage facility managing organization 4. The information processor of the power storage facility managing organization 4, depending on the information applied by the user, firstly determines a type of a preferential card to be issued (S411). In the present embodiment, three types of cards, that is, a limited card, a normal card and a limited return card, are prepared depending on the size of the investment of the user (i.e., investor for the power storage facility).

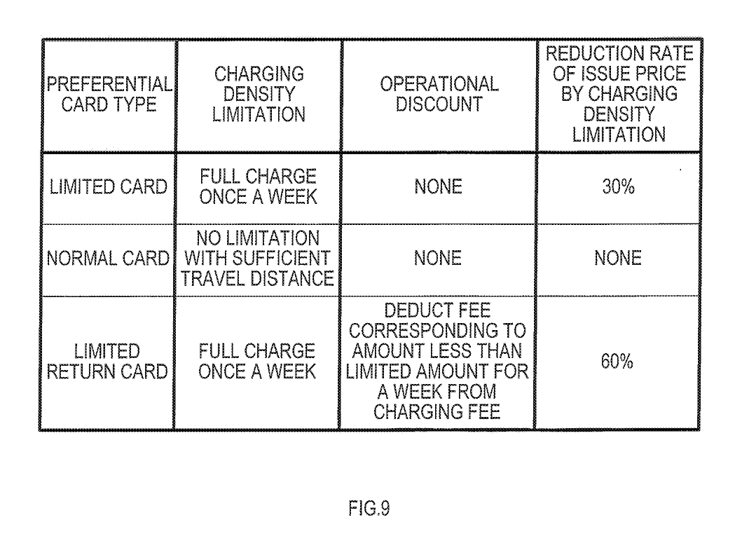

FIG. 9 shows a particular example of types of preferential cards and the content of preference.

The limited card provides services in which limitation of charging density is imposed upon charging at a preferential rate. The purpose is to enable an investor who has low frequency of use of an automobile, for example, like a user who drives only on holidays, to use a preferential card at low cost. The basis of the services is that a power storage facility is owned by a plurality of investors. Limitation on the charging density is such that, for example, the preferential rate is applied within a charging amount corresponding to an amount for fully charging an electric automobile subject to preference once a week. The extent of the charging density to be limited is set so as to measure up the size of investment in the power storage facility. With the limitation of the charging density, the issue fee of the preferential card is reduced at a predetermined ratio (30% in an example of FIG. 9).

The normal card provides services in which limitation of charging density is not imposed upon charging at a preferential rate. The condition for receiving the preferential rate is that a travel distance of an electric automobile measures up to the charging amount. The purpose is to prevent the electric power charged at the preferential rate is used for other purposes than charging of the electric automobile. The travel distance which can be the basis on whether or not the preferential rate is applied can be acquired from an automobile-mounted computer of the electric automobile at the time of charging at the charging stand 5.

The limited return card provides services in which, limitation of charging density is imposed upon charging at a preferential rate, but return money can be received in accordance with a surplus amount of power when the charging amount at the preferential rate does not reach the limitation of the charging density within a predetermined duration. The purpose is that, since the capacity of the invested power storage facility can be effectively utilized for other purpose if the investor himself/herself does not use the power storage facility for charging an automobile, part of the profit thereby generated is distributed to the investor in the form of return of the charging fee. The services are aimed at investors who own a large-scale power storage facility. The services also have an implication of a sort of social contribution. With the limitation of the charging density, the issue fee of the preferential card is reduced at a predetermined ratio (60% in an example of FIG. 9).

An example of return of charging fee is as follows. If a charging amount at the preferential rate within a week does not reach an amount of power for one full charge, when there is a limitation such that one full charge in a week is permitted, return money corresponding to an amount which does not exceed the limitation is returned at the next charging.

Returning to the flowchart of FIG. 8B, information relating to an automobile which utilizes a preferential card is inputted in S412. Here, the information is inputted for specifying an automobile utilizing the preferential card, such as the vehicle number, vehicle body number, vehicle type, etc. Subsequently, a capacity of a power storage facility of which costs borne by the user who applied for issuance of the preferential card is calculated (S413). Based on the applied information received from the user and the capacity of the power storage facility, preferential conditions (limitation of charging density, operational discount, reduction rate of issue price) in accordance with the type of preferential card determined in S411 is calculated (S414). Subsequently, power storage facility costs including a building cost, a depreciation period, an operating cost, etc. of the power storage facility for which the user has borne the costs are calculated (S415). The power storage facility costs calculated herein are used for a basis for calculating costs such as the issue price, an annual fee, etc. of the preferential card.

In S416, based on use vehicle type information inputted in S412, and the preferential conditions calculated in S414, license information (vehicle number, vehicle body number, etc.) and fee preferential class information (type of preference, discount rate, limitation of charging density, presence/absence of return money, etc.) are written in a storage area of preferential card in which no data is registered, so as to generate a preferential card. It is then determined whether or not issue conditions of a preferential card are satisfied as a result of the processes in S411-S416 (S417). If the issue conditions of a preferential card are satisfied (S417: YES), the generated preferential card is sent to the applicant (S418). If the result of the processes has inadequacy and the issue conditions of a preferential card are not satisfied (S417: NO), the present process is ended.

[Description of Processes Executed at Charging Stand 5]

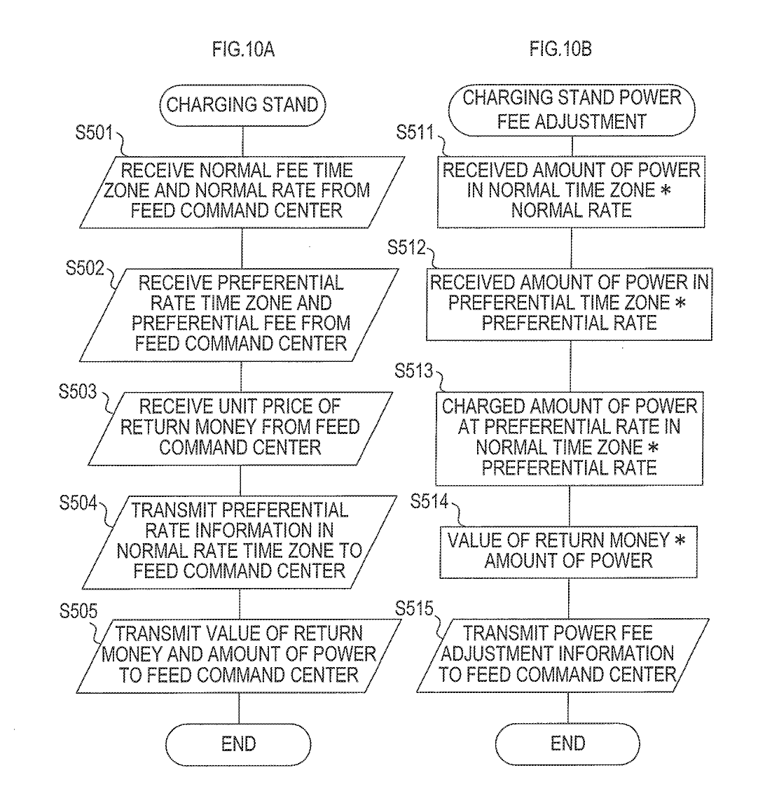

Next, processes executed at the charging stand 5 will be described based on flowcharts of FIGS. 10A, 10B, 11 and 12.

The process shown by the flowchart of FIG. 10A is executed by a central control information processor installed at the charging stand 5. The information processor of the charging stand 5 receives a time zone during which a daytime normal electricity fee is applied and a unit price (yen/VAh) of the normal rate from the feed command center 3 in S501. In S502, the information processor receives a time zone during which a nighttime preferential rate is applied and a unit price (yen/VAh) of the preferential rate. In S503, the information processor receives a unit price (yen/VAh) of return money per amount of power. At the charging stand 5, charging power is sold based on the normal rate time zone and preferential rate time zone, and unit prices of the normal rate, preferential rate and return money received in S501, S502 and S503.

In S504, the preferential rate information which indicates the amount of power required for charging performed at the preferential rate by the preferential card during the time zone when the normal electricity fees are applied is transmitted to the fee command center 3. In S505, the return money upon the return of the charging fee by the preferential card (with return), and the amount of power are transmitted to the feed command center 3. The present process is ended.

The process shown by the flowchart of FIG. 10B is executed by the central control information processor installed at the charging stand 5. The information processor of the charging stand 5 calculates in S511 electricity fees (received amount of power (VAh) during normal rate time zone*unit price of normal rate (yen/VAh)) for the amount of power received by the charging stand 5 during the daytime normal rate time zone in a period for settlement (e.g., a month). The received amount of power during the daytime normal rate time zone is acquired from a voltmeter equipped with a power receiving and transforming facility of the charging stand 5.

In S512, the information processor calculates electricity fees (received amount of power (VAh) during preferential rate time zone*unit price of preferential rate (yen/VAh)) for the amount of power received by the charging stand 5 during the nighttime preferential rate time zone in a period for settlement. The received amount of power during the preferential rate time zone is acquired from the voltmeter equipped with the power receiving and transforming facility of the charging stand 5.

In S513, the information processor calculates electricity fees (amount of charging power (VAh) at preferential rate*unit price of preferential rate (yen/VAh)) for the amount of charging power sold at the preferential rate of the preferential card during the daytime normal rate time zone in a period for settlement. The amount of charging power at the preferential rate is acquired from each of the charging units 50 installed at the charging stand 5.

In S514, the information processor calculates return money (unit price of return money (yen/VAh)*amount of charging power (VAh)) by the preferential card in a period for settlement. The amount of charging power which produces return money is acquired from each of the charging units 50 installed at the charging stand 5. In S515, the fees calculated in the processes in S511-S514 are transmitted to the feed command center 3 as power fee settlement information. The present process is ended.

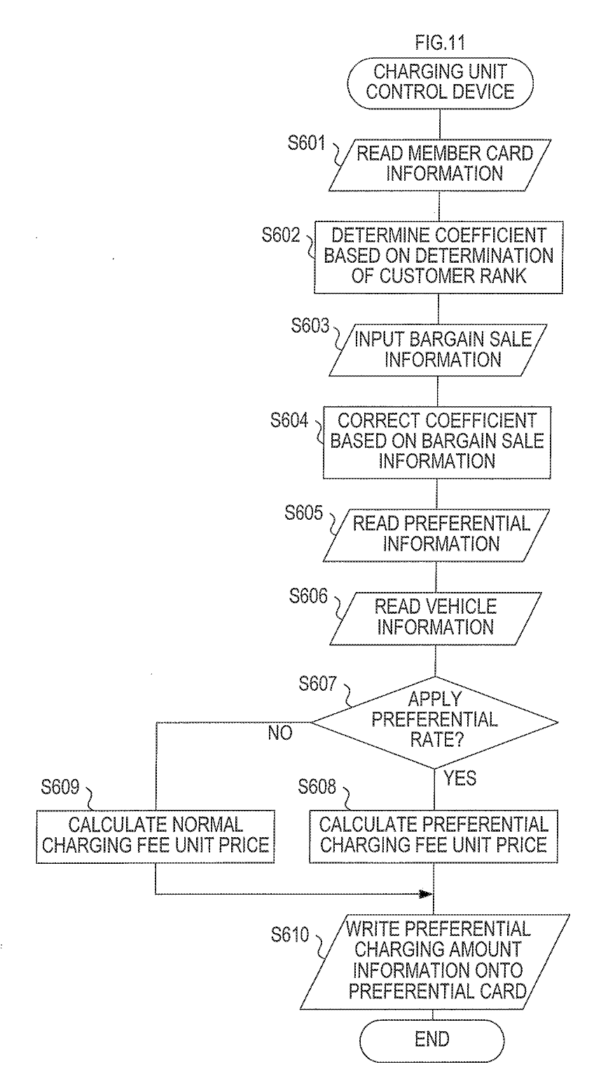

A process shown in the flowchart of FIG. 11 is started when the charging unit 50 at the charging stand 5 side and the automobile-mounted charging unit 60 at an electric automobile side are connected via their charging connectors, and a command to start charging is inputted to the charging unit 50.

The control device 53 of the charging unit 50 firstly reads information on a member card of the charging stand 5 presented by a user (S601). On the member card, information such as identification information (member number) of the user, customer rank of the user (rank specifically given to the user by the charging stand 5 side, in accordance with purchase results of the user), etc. are stored. The member card information is acquired through a not shown dedicated card reader or the central control information processor of the charging stand 5.

Subsequently, based on the customer rank read in S601, a coefficient for calculating the unit selling price of the charging fee is determined (S602). Generally, the higher the customer rank is (good customer), the lower the coefficient is set. Subsequently, bargain sale information relating to bargain sales being offered at the charging stand 5 is inputted (S603). The bargain sale information is acquired, for example, from the central control information processor of the charging stand 5. Based on the inputted bargain sale information, the coefficient determined in S602 is corrected (S604).

Subsequently, through the serial communication I/F 54, communication is performed with the control device 64 of the automobile-mounted charging unit 60 on the electric vehicle side. The preferential information stored in the preferential card 67 set in the automobile-mounted charging unit 60 is read (S605). The preferential information herein read includes the license information (vehicle number and vehicle body number) of the vehicle which can receive preference, fee preferential class information (type of preference, discount rate, limitation of charging density, presence/absence of return money), preferential charging amount information, etc.

Subsequently, through the serial communication I/F 54, communication is performed with the control device 64 of the automobile-mounted charging unit 60 on the electric vehicle side to read the vehicle information (S606). The vehicle information herein read includes the identification information (vehicle number and vehicle body number), type of storage battery, charging method, travel distance history, etc.

Based on the read preferential information and the read vehicle information, it is determined whether or not the preferential rate should be applied to the present charging (S607). Here, if conditions are satisfied such that a result of authentication of the vehicle by the license information is valid, an amount of preferential charging power within a predetermined period indicated by the preferential charging information is less than the limitation of the charging density indicated by the fee preferential class information (in the case of the limited card), and a predetermined amount of travel distance from the previous charging has been achieved (in the case of the normal card), the preferential rate by the preferential card is applied. If in the nighttime preferential fee time zone, a predetermined preferential rate is applied regardless of presence/absence of the preferential card and contents of the preferential information.

If it is determined in S607 that the preferential rate should be applied (S607: YES), the selling unit price of charging at the preferential rate (preferential charging fee unit price) is calculated (S608). The preferential charging fee unit price is calculated, for example, by an equation (1) below.

preferential charging fee unit price=(preferential rate unit price (wholesale price)+cost+profit)*coefficient (1)

The coefficient is a value, for example, of 1 to 1.1. As mentioned above, the coefficient is determined based on the customer rank and the bargain sale information.

If it is determined in S607 that the preferential rate should not be applied (S607: NO), the selling unit price of charging at the normal rate (normal charging fee unit price) is calculated (S609). The normal charging fee unit price is calculated, for example, by an equation (2) below.

normal charging fee unit price=(normal rate unit price (wholesale price)+cost+profit)*coefficient (2)

The coefficient is a value, for example, of 1 to 1.1. As mentioned above, the coefficient is determined based on the customer rank and the bargain sale information.

Thereafter, the control device 53 performs charging of an amount specified by the user to the electric automobile. In case that the preferential rate is applied to the present charging, communication with the control device 64 of the automobile-mounted charging unit 60 on the electric automobile side is performed through the serial communication I/F 54 to write the preferential charging amount information showing actual results (charging date and time, amount of charging power) of charging at the preferential rate in a predetermined storage area of the preferential card 67 (S610). The present process is ended.

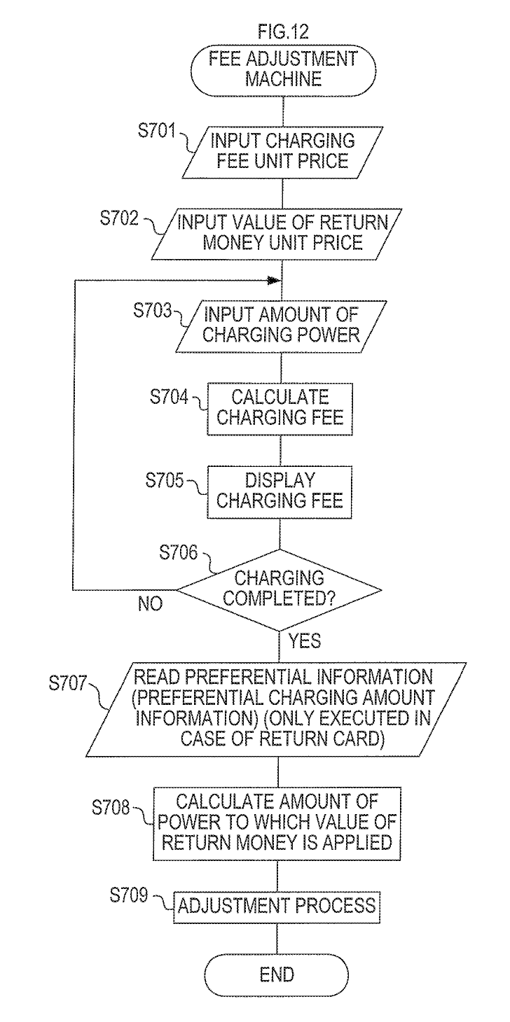

A process shown in the flowchart of FIG. 12 is started when the charging unit 50 at the charging stand 5 side and the automobile-mounted charging unit 60 at an electric automobile side are connected via their charging connectors, and a command to start charging is inputted to the charging unit 50. The fee adjustment machine 57 of the charging unit 50 inputs the charging fee unit price at the normal rate or the preferential rate calculated in S608 or S609 (FIG. 11) (S701). The fee adjustment machine 57 also inputs the unit price of the return money received in S503 (FIG. 10A) (S702).

Subsequently, an amount of charging power from when charging to an electric automobile is started till the present time is inputted from the charging machine 52 (S703). A charging fee corresponding to the amount of charging power is calculated (S704). The calculated charging fee is displayed on a display portion of the fee adjustment machine 57 (S705). It is then determined whether or not charging has been completed up to the charging amount specified by the user side (such as full charge, charging amount corresponding to XX yen, etc.) (S706). If the charging has not been completed (S706: NO), the process returns to S703. If the charging has been completed (S706: YES), the process proceeds to S707.

In S707, the control unit 53 reads the preferential information (preferential charging amount information) acquired from the preferential card 67. This process is executed only when the type of the preferential card is a return card. Based on the read preferential charging amount information, an amount of charging power covered by the return money at the present charging is calculated (S708). Here, within a range of the remaining amount of charging power obtained by deducting the amount of charging power to which return money has been applied by the time of previous charging from a predetermined total amount of charging power subject to return, the amount of charging power to which return money is to be applied is allocated. Subsequently in S709, a settlement process of the charging fee is performed. Here, the final charging fee (charging fee from which return money is deducted if any) is calculated and presented to the user. Then, payment of the charging fee (settlement) is received from the user.

[Description of Process Executed at Automobile-Mounted Charging Unit 60]

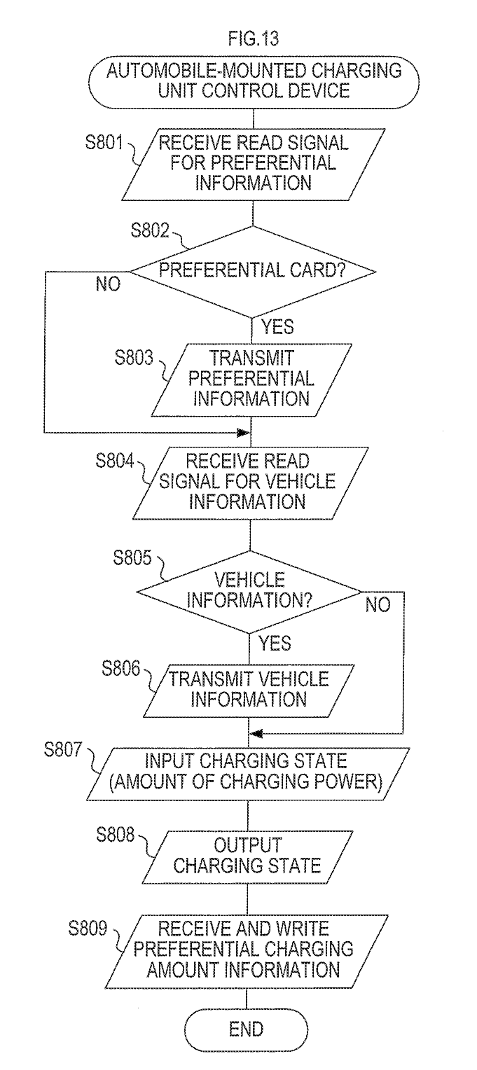

Next, a process executed at the automobile-mounted charging unit 60 of an electric automobile side will be described based on a flowchart of FIG. 13.

A process shown in the flowchart of FIG. 13 is started when the charging unit 50 at the charging stand 5 side and the automobile-mounted charging unit 60 at an electric automobile side are connected via their charging connectors, and a command to start charging is inputted. The control device 64 of the automobile-mounted charging unit 60 firstly communicates with the control device 53 at the charging unit 50 side through the serial communication I/F 65, and receives a read signal of the preferential information stored in the preferential card 67 (S801). Subsequently, it is determined whether or not the preferential card 67 is inserted to the card connector 66 (S802). If the preferential card 67 is inserted to the card connector 66 (S802: YES), the preferential information (license information, fee preferential class information, preferential charging amount information) are read from the preferential card 67, and transmitted to the charging unit 50 (S803). The process proceeds to S804. If the preferential card 67 is not inserted to the card connector 66 (S802: NO), the process proceeds to S804.

In S804, the control device 64 communicates with the control device 53 at the charging unit 50 side through the serial communication I/F 65, and receives a read signal of the vehicle information (S804). In response, it is determined whether or not the required vehicle information is stored in the ROM inside the control device 64 or on an automobile-mounted computer of the electric automobile, etc. (S805). If the vehicle information is stored (S805: YES), the vehicle information is read and transmitted to the charging unit 50 (S806). The process proceeds to S807. If the vehicle information is not stored (S805: NO), the process proceeds to S807.

In S807, the control device 64 communicates with the charging machine 62 through the serial communication I/F 65, and inputs the current charging state (progress of charging, amount of charging power from when the charging is started, etc.). Then, the inputted charging state is outputted to the console 68 and the charging unit 50 through the serial communication I/F 65 (S809).

After completion of charging, the control device 64 communicates with the control device 53 of the charging unit 50 through the serial communication I/F 65, receives the preferential charging amount information showing actual results (charging date and time, amount of charging power) of charging at the preferential rate this time, and writes the preferential charging amount information in the predetermined storage area of the preferential card 67 (S809). The present process is ended.

[Effect]

The charging fee billing system according to the above embodiment has effects as below.

(1) Upon charging an electric automobile equipped with the preferential card issued to the investor having borne costs of a commercial power system at the charging stand 5, the preferential rate at which electricity fees are discounted is always applied. According to such charging fee billing system, those having borne costs required for power storage facilities for use in a commercial power system can receive deserved benefit. Thereby, expansion of power storage facilities can be encouraged and promoted.

(2) Limitation of vehicles which can receive preference in charging fee by means of a preferential card to specified vehicles (e.g., electric automobiles for use by investors for power storage facilities) can realize an effective preference system which can adhere to the spirit of the present invention that is to grant a deserved privilege to investors having borne costs required for power storage facilities.

(3) Setting limitation, by means of the limited preferential card, to the charging density up to which the preference to the charging fee is applied inhibits excess preference which does not fit to the size of the investment in power storage facilities. A preference system can be realized which adheres to the spirit of the present invention that is to grant a deserved privilege to investors having borne costs required for power storage facilities.

(4) With the return preferential card, an investor who uses less amount of power for charging the electric automobile than the amount of power deserved for the size of investment in power storage facilities can receive profits return corresponding to a surplus amount of power. Thereby, since the capacity of power storage facilities can be used for other purpose if the investor does not use the invested power storage facilities for charging of the vehicle, part of the profits thereby produced can be received by the investor in the form of return of the charging fee.

### Other Exemplary Embodiments

Other embodiments to which the present invention can be applied will be described below.

(1) Those to whom a preferential rate is applied may not be limited to investors having borne costs required for power storage facilities. Investors having borne costs required for power generation facilities utilizing natural energy such as photovoltaic generation facilities and wind power generation facilities may be included in those to whom a preferential rate is applied. Expansion of such power generation facilities utilizing natural energy can also cope with increase in demand for electric power which accompanies the spread of an electric automobile, and adheres to the spirit of the present invention that is to encourage installation of power facilities.

(2) Or, investors having borne costs required for fuel cell power generation facilities which are expected to be spread in recent years as distributed generation facilities may be included in those to whom a preferential rate is applied. Expansion of such distributed generation facilities can also cope with increase in demand for electric power which accompanies the spread of an electric automobile, and adheres to the spirit of the present invention that is to encourage installation of power facilities.

(3) Also, an investor having borne costs required for photovoltaic generation facilities, wind power generation facilities and fuel cell power generation facilities may be allowed to sell excess amount of power to a power company if the amount of power utilized for charging the electric automobile owned by the investor is smaller than the generated amount of power of the power generation facilities. Such service provides incentives to encourage installation of power facilities.

(4) As an embodiment, the preferential card 67 storing the preferential information may be used in combination with an ETC card for use in an automatic fare collection system (ETC (registered trademark): Electronic Toll Collection) which has already been widely spread in Japan. In that case, the ETC card stores, in addition to information for use in settlement of expressway toll, preferential information for the charging fee relating to the present invention. Also, an ETC automobile-mounted unit may be used as a card reader/writer connected to the automobile-mounted charging unit. Such configuration can unify settlement of expressway toll and preferential service of charging fee into a single card, thereby being convenient.

(5) Information communication among the charging stand 5, the feed command center 3 and others may be performed by power line carrier communication which uses a power transmission and distribution network as a communication circuit.

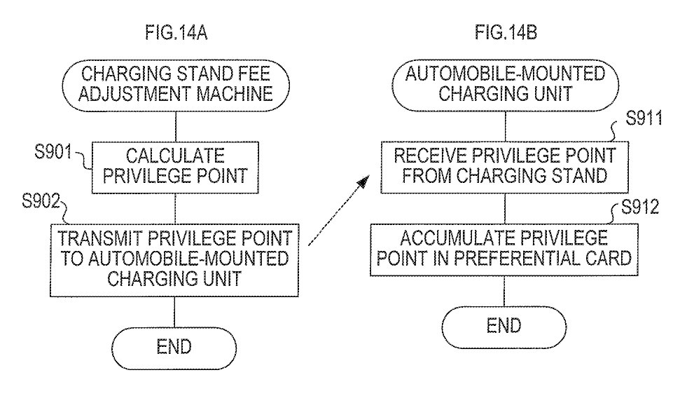

(6) In order to promote the spread and use of the charging fee preferential service of the present invention, other various services may be used, such as offering other privilege point other than a discount of the charging fee each time charging to which the preferential rate is applied is done, and allowing the privilege point to be used as cash upon shopping, etc. For example, a privilege point offered each time charging is performed at a charging stand is recorded on the preferential card 67. Particularly, as shown in the flowchart of FIG. 14A, the fee adjustment machine 57 on the charging stand side calculates the privilege point (S901) and transmits the information to the automobile-mounted charging unit 60 (S902). Also, as shown in the flowchart of FIG. 14B, the control device 64 of the automobile-mounted charging unit 60, when receiving information of the privilege point from the charging stand side (S911) accumulates the privilege point in a predetermined storage area of the preferential card 67 (S912). The user presents the preferential card 67 at a shop. The privilege point is read out by a card reader at the shop. The read out privilege point may be consumed by the user buying products and services.

1. A charging fee billing method comprising:
a providing step in which, to an investor having borne costs required for power storage facilities that are connected to a commercial power system, store electric power supplied from the commercial power system and supply the stored electric power to the commercial power system, preferential information on preferential right is created by which a discount for electricity fees involved in charging of a storage battery mounted on an electric automobile for use by the investor can be received, and a preferential information recording medium that stores the created preferential information is given;
an acquisition step in which, upon charging the electric automobile equipped with the preferential information recording medium by a charging stand device which receives power supply from the commercial power system, the preferential information is acquired from the preferential information recording medium; and
a billing step in which, based on the preferential information acquired from the preferential information recording medium in the acquisition step, a charging fee is billed which is an electricity fee involved in charging of the electric automobile by the charging stand device to which a preferential rate is applied.

2. The charging fee billing method according to claim 1,
wherein the preferential information created in the providing step includes identification information for specifying an electric automobile which can receive preference in charging fee, and,
in the billing step, the electric automobile is authenticated based on the identification information included in the preferential information, and the preferential rate is applied only to the electric automobile being complied with the identification information.

3. The charging fee billing method according to claim 1,
further comprising a storage step in which charging information showing actual results of charging which has been performed at the preferential rate to the electric automobile equipped with the preferential information recording medium is stored,
wherein the preferential information created in the providing step also includes limitation information showing limitation to charging density up to which the preferential rate can be applied, and,
in the billing step, the preferential rate is applied to the electricity fees involved in charging within a limited range for the charging density shown by the limitation information, based on the limitation information included in the preferential information and the charging information stored in the preferential information recording medium.

4. The charging fee billing method according to claim 1,
further comprising a storage step in which charging information showing actual results of charging which has been performed at the preferential rate to the electric automobile equipped with the preferential information recording medium is stored,
wherein the preferential information created in the providing step includes return information showing a condition for returning the charging fee in case that charging covered at the preferential rate is smaller than the previously arranged charging density, and,
in the billing step, if the actual results of the charging density based on the charging information stored in the preferential information recording medium are smaller than the previously arranged charging density based on the return information included in the preferential information, return money corresponding to an amount less than the previously arranged charging density is deducted from the charging fee.

5. A charging fee billing system comprising:
a charging stand device that receives supply of electric power from a commercial power system; and an automobile-mounted charging device mounted on an electric automobile,
wherein the automobile-mounted charging device includes:
a charging unit that receives power supply from the charging stand device by electrically connecting with the charging stand device to charge a storage battery mounted on the electric automobile;
a preferential information recording unit that stores preferential information on preferential right granted to an investor having borne costs required for power storage facilities that are connected to a commercial power system, store electric power supplied from the commercial power system and supply the stored electric power to the commercial power system, the preferential right being a right of receiving a discount for electricity fees involved in charging of the storage battery mounted on the electric automobile for use by the investor;
an automobile-mounted communication unit that is for information communication with the charging stand device; and
a transmission unit that transmits contents stored in the preferential information recording unit to the charging stand device via the automobile-mounted communication unit,
wherein the charging stand device includes:
a stand-side charging unit that supplies electric power for charging the storage battery mounted on the electric automobile to the automobile-mounted charging device by electrically connecting with the automobile-mounted charging device;
a stand-side communication unit that is for information communication with the automobile-mounted charging device;
an acquisition unit that acquires information stored in the preferential information recording unit provided in the automobile-mounted charging device via the stand-side communication unit; and
a billing unit that bills a charging fee which is an electricity fee involved in charging of the electric automobile to which a preferential rate is applied, based on the preferential information acquired from the automobile-mounted charging device by the acquisition unit.

6. The charging fee billing system according to claim 5,
wherein the preferential information includes identification information for specifying an electric automobile which can receive preference in charging fee,
the billing unit of the charging stand device authenticates the electric automobile based on the identification information included in the preferential information, and the preferential rate is applied only to the electric automobile being complied with the identification information.

7. The charging fee billing system according to claim 5,
wherein the preferential information includes limitation information showing limitation for charging density up to which the preferential rate can be applied,
the automobile-mounted charging device further includes a storage unit that stores in a preferential information recording unit charging information showing actual results of charging which has been performed at the preferential rate, and
the billing unit of the charging stand device applies the preferential rate to the electricity fees involved in charging within a limited range for the charging density shown by the limitation information, based on the limitation information included in the preferential information and the charging information stored in the preferential information recording unit.

8. The charging fee billing system according to claim 5,
wherein the preferential information includes return information showing a condition for returning the charging fee in case that charging covered at the preferential rate is smaller than the previously arranged charging density,
the automobile-mounted charging device further includes a storage unit that stores in a preferential information recording unit charging information showing actual results of charging which has been performed at the preferential rate, and
the billing unit of the charging stand device, if the actual results of the charging density based on the charging information stored in the preferential information recording unit are smaller than the previously arranged charging density based on the return information included in the preferential information, deducts return money corresponding to an amount less than the previously arranged charging density from the charging fee.

9. The charging fee billing system according to claim 5,
wherein the charging stand device and the automobile-mounted charging device are chargeably connected via charging terminals so that the automobile-mounted communication unit and the stand-side communication unit can perform information communication with each other.

10. A charging stand device that constitutes the charging fee billing system according to claim 5.

11. An automobile-mounted charging device that constitutes the charging fee billing system according to claim 5.
